(19) United States
(12) Patent Application Publication
(10) Pub. No.: US 2023/0271634 A1
(43) Pub. Date: Aug. 31, 2023

(54) METHOD AND DEVICE FOR CONTROLLING A CABLE TRANSPORT SYSTEM AND SYSTEM COMPRISING SUCH A CONTROL DEVICE

(71) Applicant: POMA, Voreppe (FR)

(72) Inventors: Clémence SÈVE, Saint Laurent du Pont (FR); Christian MATHIEU, Seyssins (FR)

(73) Assignee: POMA, Voreppe (FR)

(21) Appl. No.: 18/009,053

(22) PCT Filed: Jun. 9, 2021
(86) PCT No.: PCT/EP2021/065533

§ 371 Date: Dec. 8, 2022

(30) Foreign Application Priority Data
Jun. 10, 2020 (FR) 2006076

(51) Int. Cl. B61B 12/06; B61B 7/00

(52) U.S. Cl. CPC B61B 12/06; B61B 7/00

(57) ABSTRACT

A device for monitoring a cableway installation, the installation including a carrier vehicle designed to be hauled by a cable, the device including: for detecting entry of a vehicle in a running zone, for calculating a variable representative of a running length of the cable, for comparing the calculated variable with a threshold, and determining configured to determine receipt of an event indicating exit of the vehicle from the running zone, the monitoring device being configured to transmit a malfunction signal after the calculated variable has reached the threshold and the event has not been received.

### BACKGROUND OF THE INVENTION

The invention relates to a device for monitoring a cableway installation, to a cableway installation comprising one such monitoring device and to a method for monitoring a cableway installation.

### STATE OF THE ART

Cableway installations, in particular installations that transport people, comprise carrier vehicles hauled by a cable, called hauling cable, that run from one passenger boarding/alighting terminal to the other. The installation generally comprises towers to guide and support the hauling cable. These towers are placed along the running path of the vehicles. Carrier vehicles may exceptionally find themselves blocked on a tower, and more dangerously several vehicles may run into one another on the same tower. It is therefore necessary to be able to monitor correct running of the vehicles when passing a tower.

French Patent application FR2996514 can be cited disclosing a method for monitoring the travel of vehicles in a terminal of a chairlift or a gondola lift, in which a distance separating two vehicles can be determined from determination of the positions of the vehicles in a zone of a terminal, and the running speed is modified if the separating distance is less than a safety distance. But the distances that vary have to be calculated thereby making the method complex to implement.

German Patent application DE 102017219219 can be cited disclosing cars hauled by a cable moving on a rail. The cars are equipped with sensors communicating with apparatuses positioned on towers to regulate the distance between cars or the speed of the cars in the proximity of elements of the installation. European Patent application EP2977286 can also be cited disclosing a method for retrieving measurements made with a measurement sensor situated on the route taken by a vehicle, in which the vehicle comprises a unique radiofrequency identification tag. The measurements are retrieved via tag when the vehicle passes close to the sensor and the measurements are then retrieved on a radiofrequency reader situated in a terminal. But these methods do not enable correct running of the vehicles between two terminals to be monitored.

French Patent application FR2941206 can also be cited disclosing a device for monitoring running of vehicles in a terminal of a cableway installation. When the vehicles are uncoupled from the cable and guided on rails, the device for monitoring running transmits signals each time a vehicle is detected by a fixedly installed detection means. Two detection means define entry to and exit from a monitoring zone. When a detection means detects a vehicle entering the monitoring zone, a meter is activated to monitor the travel of the cable until the vehicle is detected on exit from the monitoring zone. The value of the meter is compared with a threshold to detect a malfunction. The threshold depends on the vehicle throughput of the installation, the curvature radius of the installation, the space occupation of the vehicles, and the reduction ratio between the running speed of the cable and the drive speed of the uncoupled vehicles.

Another meter is disclosed that represents the length of cable between two detections of two consecutive vehicles by the same sensor so as to monitor the distance separating the two consecutive vehicles. To detect a malfunction, this other meter is compared with another threshold that is dependent on the speed of the cable and/or the running rate of the vehicles.

### SUMMARY OF THE INVENTION

One object of the invention consists in remedying these shortcomings and more particularly in providing means for monitoring correct running of the vehicles hauled by a cable and in particular when crossing monitoring points.

Another object consists in providing a monitoring means that is simple and robust.

According to one feature of the invention, a method for monitoring a cableway installation is proposed, the installation comprising a vehicle designed to be hauled by a cable, the method comprising: detection of entry of the vehicle in a running zone, calculation of a variable representative of a running length of the cable, and comparison of the calculated variable with a threshold.

The method comprises determination of receipt of an event indicating exit of the vehicle from the running zone, and after the calculated variable has reached the threshold, transmission of a malfunction signal if the event is not received.

A simple method is thereby provided for determining whether a vehicle has in fact passed through a specific running zone. The running zone can be situated between two terminals. The method is also suitable for a running zone situated within one of the terminals.

The installation can comprise measuring means configured to provide pulses according to the travel of the cable, and the calculation comprises calculation of the variable from the pulses provided by the measuring means.

The installation can also comprise detection means designed to transmit a first signal indicating entry of the vehicle in the running zone and designed to transmit a second signal indicating exit of the vehicle from the running zone, and the event corresponds to receipt of the second signal.

The threshold can be determined according to a length of the running zone.

According to another feature, a monitoring device of a cableway installation is proposed, the installation comprising a vehicle designed to be hauled by a cable, the device comprising: means for detecting entry of the vehicle in the running zone, means for calculating a variable representative of a running length of the cable, and means for comparing the calculated variable with a threshold.

The device comprises determining means configured to determine receipt of an event indicating exit of the vehicle from the running zone, the monitoring device being configured to transmit a malfunction signal after the calculated variable has reached the threshold and the event has not been received.

The device can comprise measuring means configured to provide pulses according to the travel of the cable, and the calculating means calculate the variable from the pulses provided by the measuring means.

The detection means can be designed to transmit a first signal indicating entry of the vehicle in the running zone and designed to transmit a second signal indicating exit of the vehicle from the running zone, and the determining means comprise a receiver of the first and second signals, and the event corresponds to receipt of the second signal.

The comparison means can determine the threshold according to a length of the running zone.

According to another feature, a cableway installation is proposed comprising a cable, a vehicle designed to be hauled by the cable, and a monitoring device as defined above.

### DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a cableway installation equipped with a monitoring device according to the invention;

FIG. 2 schematically illustrates a first step of a monitoring method according to the invention;

FIG. 3 schematically illustrates a second step of a monitoring method according to the invention;

FIG. 4 schematically illustrates a third step of a monitoring method according to the invention; and

FIG. 5 schematically illustrates a fourth step of a monitoring method according to the invention.

### DETAILED DESCRIPTION

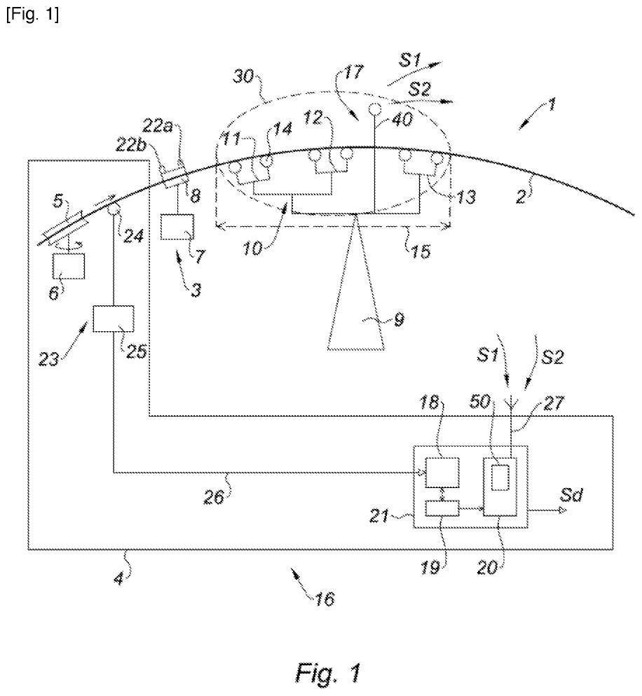

In FIG. 1, a cableway installation 1 has been represented comprising a cable 2 and one or more vehicles 3 designed to be hauled by the cable 2. Installation 1 comprises a terminal 4 for passengers to board and alight from vehicles 3. The installation 1 comprises a bull-wheel 5 driving the cable 2. The bull-wheel 5 is driven in rotation by a motor 6. Vehicles 3 designed to transport people respectively comprise a car 7, or a chair, attached to the cable 2 via a clamp 8. The clamp 8 can open and close to attach vehicles 3 in removable manner to the cable 2 and installation 1 is of detachable type. As a variant, the clamp 8 can be fixed to attach vehicles 3 in permanent manner to the cable 2 and the installation is of non-detachable type.

Installation 1 further comprises one or more towers 9 to keep the cable 2 above the ground. The tower 9 generally comprises a girder assembly 10 comprising one or more beams 11 to 13 equipped with rotationally mounted sheaves 14 to guide the cable 2 and enable the latter to move. Vehicles 3 are hauled by the cable 2 and pass over the tower 9 to go from one terminal 4 to the other. Installation 1 comprises at least one running zone 15 in which the passage of vehicles 3 is to be monitored. In FIGS. 1 to 5, an installation 1 has been represented comprising a running zone 15. A running zone 15 can correspond to a space comprised between the two ends of the girder assembly 10. For example, the length of the running zone 15 is equal to a length of the girder assembly 10. Installation 1 can also comprise several running zones 15 situated along the route of vehicles 3, i.e. between two terminals 4. One or more running zones 15 can also be situated in a terminal 4. Furthermore, two successive running zones can be adjacent or at a distance from one another.

More particularly, installation 1 comprises a monitoring device 16 to monitor running of vehicle(s) 3 in the running zone 15. In general manner, the monitoring device 16 comprises an electronic control unit 21. The monitoring device 16 checks whether a vehicle 3 has passed the running zone 15 correctly. In other words, the monitoring device 16 checks that a vehicle 3 is not blocked in the running zone 15 to prevent a collision between the blocked vehicle and another vehicle. Vehicles 3 are attached to the cable 2 in the running zone 15.

The monitoring device 16 comprises the detection means 17, the calculating means 18, the comparison means 19 and the determining means 20. For example, the calculating means 18, the comparison means 19 and the determining means 20 are logic circuits integrated in the electronic control unit 21.

The detection means 17 are configured to detect entry of the vehicle 3 in the running zone 15 of the vehicle 3. In general manner, the detection means 17 are designed to transmit a first signal S1 indicating entry of the vehicle 3 in a running zone 15 and are designed to transmit a second signal S2 indicating exit of the vehicle 3 from the running zone 15. The detection means are formed by detectors.

For example, the detection means 17 comprise one or more sensors 40, 41 detecting the presence of a vehicle 3. The sensors 40, 41 detecting the presence of a vehicle 3 are configured to respectively transmit first and second signals S1, S2. For example, the sensors 40, 41 are RFID readers. In this case, clamps 8 of vehicles 3 are equipped with one or two radiofrequency tags 22a, 22b. For example, a sensor 40, 41 can comprise an integrated signal transmitter to transmit first and second signals S1, S2. As a variant, two sensors 40, 41 can be connected to the same remote transmitter to transmit first and second signals S1, S2. The detectors are configured to detect the presence of a vehicle and to transmit a signal representative of this detection. When the detection means detect entry of the vehicle 3 in the running zone 15, for example by means of the at least one sensor 40, they transmit a signal enabling the monitoring device 16 to know the real and precise position of the vehicle 3 in the cableway installation 1.

The detection means 17 can comprise a sensor 40 having a detection area 30. When the vehicle 3 enters the detection area 30, the sensor 40 transmits first signal S1 indicating entry of the vehicle 3 in the running zone 15. When the vehicle 3 exits the detection area 30, the sensor 40 transmits second signal S2 indicating exit of the vehicle 3 from the running zone 15. The sensor 40 has a detection area that extends over the whole length of the running zone 15 thereby enabling a single sensor 40 to be used.

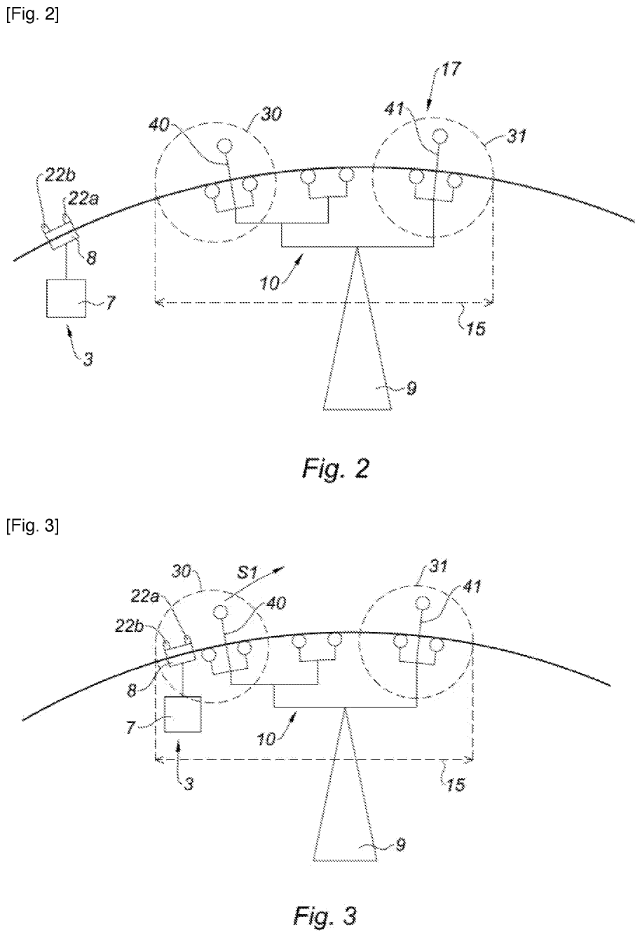

As a variant, as illustrated in FIGS. 2 to 5, the detection means 17 comprise two sensors 40, 41 each having a respective detection area 30, 31. When the vehicle 3 enters the first detection area 30, the first sensor 40 transmits first signal S1 indicating entry of the vehicle 3 in the running zone 15. When the vehicle 3 leaves the second detection area 31, the second sensor 41 transmits second signal S2 indicating exit of the vehicle 3 from the running zone 15. A sensor 40 is present at the entry of the running zone 15 to detect entry of the vehicle 3 in the running zone 15. A sensor 41 is present at the exit of the running zone 15 to detect exit of the vehicle 3 from the running zone 15.

In general manner, an entry in the running zone 15 and an exit from the running zone 15 is associated with each the running zone 15. Furthermore, one sensor 40 can be used per the running zone 15. The sensor 40 is configured to detect passage of a vehicle 3 at the entry of the running zone 15 and the sensor 40 transmits first signal S1. The sensor 40 is also configured to detect passage of a vehicle 3 at the exit from the running zone 15 and the sensor 40 transmits second signal S2. As a variant, two sensors 40, 41 associated with a running zone 15 can be used. In this case, a first sensor 40 is configured to detect passage of a vehicle 3 at the entry of the running zone 15 and the first sensor 40 transmits first signal S1. The second sensor 41 is configured to detect passage of a vehicle 3 at the exit from the running zone 15 and the second sensor 41 transmits second signal S2. According to yet another alternative embodiment, two sensors 40, 41 can be used associated with a running zone 15 and configured to respectively detect passage of a vehicle 3 at the entry to the running zone 15 and passage of a vehicle 3 at the exit from the running zone 15. The two sensors 40, 41 can be connected to the same transmitter designed to transmit first and second signals S1, S2, or each sensor 40, 41 comprises an integrated signal transmitter. According to yet another variant, a sensor 40 can be associated with several running zones 15. In this case, the detection area 30 of the sensor 40 covers all the running zones 15, in particular the entry to the first running zone and the exit from the last running zone. In this case, the sensor 40 is configured to detect passage of a vehicle 3 at the entry of each the running zone 15 and to transmit a first signal S1 associated with each entry in a detected running zone. The sensor 40 is furthermore configured to detect passage of a vehicle 3 at the exit from each running zone and to transmit a second signal S2 associated with each exit from a detected the running zone 15.

The calculating means 18, for example a computer such as a micro-processor, are configured to calculate a variable representative of a running length of the cable 2. For example, the monitoring device 16 can comprise the measuring means 23, for example a measurement device, configured to provide pulses according to the travel of the cable 2. The measuring means 23 can comprise a the rotary encoder 24 in contact with the cable 2 connected to a the pulse generator 25. When the cable 2 is driven in translation by the bull-wheel 5, the rotary encoder 24 rotates and the pulse generator 25 generates a pulse according to the rotation of the rotary encoder 24. For example, generator 25 generates a pulse at each rotation of the rotary encoder 24. In other words, the pulse generator 25 generates pulses at each running of the cable 2 when the latter is moving. In particular, the pulse generator 25 is connected to the calculating means 18 via a connection 26. The calculating means 18 are configured to calculate the variable from the pulses provided by the measuring means 23. In other words, the calculated variable corresponds to a number of pulses generated by the pulse generator 25. As an alternative, the measuring means 23 are configured to measure the rotation of the bull-wheel 5 performing driving of the cable 2 so as to determine the progression of the cable 2.

The calculating means 18 provide a variable that is representative of the running length of the cable 2 from the time the vehicle 3 has been detected at the entry of a running zone 15. In preferential manner, the calculating means 18 are configured to calculate a new variable each time a vehicle 3 enters a new the running zone 15. For example, on receipt of the signal indicating entry of the vehicle 3 in the running zone 15, the calculating means 18 calculate a variable representative of a running length of the cable 2. The variable representative of a running length of the cable 2 enables the running of the vehicle 3 along the cableway installation 1 to be calculated as a function of time thereby enabling a theoretical position of the vehicle 3 to be calculated from running of the cable 2.

Advantageously, the calculating means 18 are means for calculating a variable from the length of the cable 2 that has run and not from the speed of the cable 2.

As the variable is calculated from the length of the cable 2 that has run since detection took place, the measurement is more precise. The variable makes it possible to estimate the position of the vehicle 3 that is considered to be kept immobile with respect to the cable 2. When the detection means detect exit of the vehicle 3 from the running zone 15, for example by means of the at least one sensor 40, they transmit a signal enabling the monitoring device 16 to know the precise real position of the vehicle 3 in cableway installation 2.

The comparison means 19, for example a comparator, are configured to compare the calculated variable with a threshold. Advantageously, the comparison means 19 determine the threshold according to a length of the running zone 15. For example, the length of the running zone 15 can be equal to the total length of the girder assembly 10 or to the length of a part of the girder assembly 10. In particular, the threshold corresponds to a specific running length of the cable 2 corresponding to the length of the running zone 15.

The determining means 20, for example a computer, are configured to determine receipt of an event indicating exit of the vehicle 3 from the running zone 15. For example, the determining means 20 comprise a receiver 27, for example an antenna, configured to receive first and second signals S1, S2. The event indicating exit of the vehicle 3 from the running zone 15 corresponds to receipt of second signal S2. On the contrary, if the vehicle 3 does not exit from the running zone 15, for example if it remains blocked in the running zone 15, second signal S2 is then not transmitted by the detection means 17 and second signal S2 is not received by the determining means 20. Advantageously, the determining means 20 comprise a memory 50 to store signals S1, S2 received by the receiver 27. The determining means 20 periodically question the memory 50 to determine receipt of second signal S2. The questioning period can be equal to or less than the maximum number of pulses per second generated by the pulse generator 25.

In advantageous manner, the real position of the vehicle 3 can be compared with the position estimated from the variable representative of a running length of the cable 2. If the two positions are different, i.e. the difference between the two positions is greater than a threshold value, a malfunction signal is then transmitted. When the difference between the two positions is lower than a threshold value or even zero, no malfunction signal is sent.

The variable representative of a running length of the cable is compared with a threshold value. The threshold value corresponds to the maximum length of travel of the vehicle 3 to obtain passing of this the vehicle 3 through the exit position of the running zone. The exit position from the running zone with respect to the entry of the running zone is represented by the threshold value.

When the comparison means 19 regularly compare the value of the variable representative of a running length of the cable with the threshold value, the monitoring device 16 checks that the vehicle is located between the entry and exit of the running zone 15. When the comparison means 19 ascertain that the value of the variable representative of a running length of the cable reaches the threshold value, it is important to check whether the detection device detects or has already detected the presence of the vehicle in the exit zone of the running zone 15.

The monitoring device 16 is preferably used in the following manner. When entry of the vehicle 3 in the running zone 15 is detected, for example when the determining means 20 receive first signal S1, the variable representative of a running length of the cable 2 is calculated. Then, while the vehicle 3 hauled by the cable 2 passes through the running zone 15, the variable is compared with the threshold. Preferentially, the variable is compared periodically with the threshold. Then, when the variable reaches the threshold, it is determined whether the event indicating exit of the vehicle 3 from the running zone 15 has been received. Two situations can then be considered. Either the event has been received and in this case the vehicle 3 has passed the running zone 15 correctly. In particular, the vehicle 3 is considered to have passed the running zone 15 with an expected running length of the cable 2. Or the event has not been received and in this case the vehicle 3 is blocked in the running zone 15 or the vehicle 3 has come detached from the cable 2. If the event is not received, whereas the calculated variable has reached the threshold, the monitoring device 16 is configured to transmit a malfunction signal Sd. In other words, the vehicle 3 is considered not to have passed the running zone 15 correctly after the calculated variable has reached the threshold and the event is not received, i.e. second signal S2 is not received. When malfunction signal Sd is transmitted, running of the cable 2 can be slowed down or it can also be stopped.

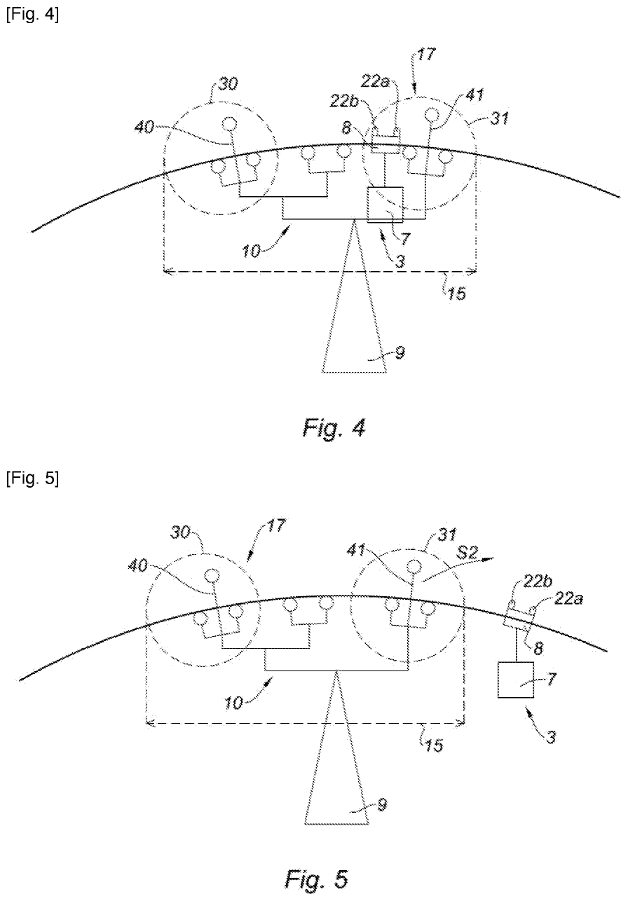

In FIG. 2, running of a vehicle 3 approaching the tower 9 has been represented. The vehicle 3 is outside the running zone 15. In FIG. 3, entry of the vehicle 3 in the running zone 15 has been represented. In this case, the first sensor 40 transmits first signal S1 indicating that the vehicle 3 has entered the running zone 15. For example, first signal S1 is transmitted when a first tag 22a of the vehicle is present in the first detection area 30. In FIG. 4, the vehicle 3 moving inside the running zone 15 has been represented. In particular, the vehicle 3 enters a second detection area 31 of the second sensor 41. In FIG. 5, the vehicle 3 exits the running zone 15 and the second sensor 41 transmits second signal S2. For example, second signal S2 is transmitted when a second tag 22b of the vehicle 3 leaves the second detection area 31.

The invention that has just been described makes it possible to determine simply and accurately that a vehicle has correctly passed a crossing zone. Collisions between vehicles in the crossing zone can thus be limited, thereby limiting the occurrence of serious accidents.

In an embodiment where the running zone 15 is monitored by a single sensor 40, first signal S1 is an entry signal of the vehicle in the running zone 15, for example a rising or falling edge of a quantity. Second signal S2 is an exit signal of the vehicle from the running zone 15, for example a rising or falling edge of said quantity. The quantity is preferentially an electric quantity, for example a current or a voltage. When two sensors 40, 41 are used to demarcate the running zone 15, signals S1 and S2 can be two rising edges or two falling edges or a rising edge and a falling edge or other signal shapes.

Detection of a vehicle 3 at the entry of a running zone 15 by means of the first sensor 40 triggers calculation of the variable representative of a running length of the cable 2. In other words, the calculating means 18 calculate a variable that represents the length of the cable 2 running in the running zone 15 from the moment the vehicle 3 is detected at the entry of the running zone 15. The length of the cable 2 that runs in the running zone 15 is representative of the theoretical position of the vehicle 3 in the running zone 15 in the direction of the exit. The variation of the variable represents the travel of the cable 2 and expresses the theoretical travel of the vehicle 3 in the running zone 15.

The comparison means 19 are configured to compare the variable representative of a running length of the cable 2 with the threshold value that is representative of the length of the running zone. The threshold represents the maximum permitted running length of the cable 2 through the running zone 15 before an abnormal situation is considered to have arisen.

When the comparison means 19 compare the variable representative of a running length of the cable 2 with the threshold representative of the length of the running zone 15, the comparison means 19 compare the theoretical position of the vehicle 3 with respect to the position representing the exit limit from the running zone 15. When the variable representative of a running length of the cable 2 reaches the threshold value, this means that the theoretical position of the vehicle 3 corresponds to an exit from the running zone 15 and preferentially to a vehicle 3 located slightly after the exit from the running zone 15. To take account of measurement uncertainties, the threshold value is slightly greater than the strict length of the cable 2 in the running zone 15.

When the variable representative of a running length of the cable 2 reaches the threshold value, the monitoring device 16 can question determination device 20 to know whether receipt of an event indicating exit of the vehicle 3 from the running zone 15 has been determined. In another specific case, when the determining means 20 determine receipt of an event indicating exit of the vehicle 3 from the running zone 15, they notify the monitoring device 16 directly.

When the monitoring device 16 detects that the variable representative of a running length of the cable 2 reaches the threshold value and no event exists representative of exit of the vehicle 3 from the running zone, a malfunction signal Sd is transmitted. The real position of the vehicle 3 has deviated from the theoretical position by a sufficient distance to be considered to be abnormal.

When the monitoring circuit determines that the vehicle 3 has left the running zone 15 before the used length of the cable 2 representative of a malfunction (the threshold) has been reached, the situation can be considered to be normal and does not require transmission of malfunction signal Sd.

In a particular embodiment, the comparison is stopped when the sensor 40 detects exit of the vehicle from the running zone. Consequently, when the comparison means comprise the variable representative of a running length of the cable 2 with the threshold representative of the length of cable in the running zone and detect that the variable reaches the threshold value, this implicitly corresponds to non-receipt of an event indicating exit of the vehicle 3 from the running zone 15. In opposite manner, when an event indicating exit of the vehicle is received before the variable reaches the threshold value, this stops the comparator that can be used for monitoring a new vehicle in the running zone or for monitoring the vehicle in another running zone or other possibilities.

The sensor at the entry of a running zone enables a first position of the vehicle 3 on the cable 2 to be defined. The sensor on exit from the running zone 15 enables a second position of the vehicle on the cable 2 to be defined. The real position determined by the at least one sensor on exit from the running zone is compared with the estimated position defined by the variable representative of a running length of the cable 2. According to the result of the comparison, the two positions are considered to be identical or different thereby enabling a normal situation or a malfunction to be identified.

The use of a variable representative of the length of cable travelled in the running zone from detection of a vehicle at the entry of the running zone is particularly advantageous. This enables the length of the cable 2 that has passed to be monitored independently from the speed, from possible stoppages of the installation or from the shape of the running zone 15.

Comparison of the variable with a threshold value makes it possible to monitor the estimated position of the vehicle 3 with respect to a reference position corresponding to the exit position from the running zone. The comparison enables it to be determined whether the vehicle has deviated from its reference position beyond a threshold distance representative of a malfunction.

The monitoring device 16 is configured to prevent a collision between vehicles 3 by monitoring the position of each the vehicle 3 with respect to its reference position, i.e. its theoretical position on the cable 2. The reference position is redefined at the entry of each the running zone 15, which enables measurement uncertainties for example related to a modification of the load applied on a girder assembly to be minimised or even eliminated. According to the load applied on the girder assembly, the latter can deform between a “flat” position and a “rounded” position. The length of cable necessary to pass through a girder assembly is shorter when the girder assembly is “flat” than when the girder assembly is totally “rounded”.

In a particular embodiment, the route between two terminals 4 is divided into a multitude of running zones 15 that follow on from one another so that the exit of one running zone 15 corresponds to the entrance of the next the running zone 15.

It is also possible to provide for several running zones to be superposed. For example, the first running zone is included in the second running zone. The first and second running zones share the same sensor detecting entry in the running zones. It is advantageous for several running zones to have the same entry thereby enabling a single sensor to be used to detect entry in the multiple running zones. The multiple running zones have a specific exit that is associated with a specific sensor. In preferential manner, the entry zone corresponds to an area of a terminal and the exit zone corresponds to a tower. The monitoring circuit is configured to monitor running of the different vehicles between a terminal and the multiple towers of the cableway installation.

A first variable is defined and compared with a first threshold to detect a risk situation in first the running zone 15. A second variable is defined and compared with a second threshold to detect a risk situation in second the running zone 15 outside the first running zone. Comparison of the first variable with the first threshold enables a risk situation to be detected as indicated in the foregoing.

Comparison of the second variable with the second threshold enables a less obvious risk situation to be detected, for example a slow slipping of the vehicle.

It is particularly advantageous to compare the variable with the threshold several times in the period of time that represents the theoretical running of the vehicle in the running zone.

1. A method for monitoring a cableway installation, the installation comprising at least one vehicle provided with a clamp attaching the vehicle to the cable, the method comprising:
detection of entry of the at least one vehicle in a running zone to trigger calculation of a variable that is representative of a running length of the cable starting from the detection,
comparison of the variable with a threshold,
transmission of a malfunction signal when the variable has reached the threshold,
wherein the clamp is fixed to the cable so that the cable hauls the vehicle when the vehicle is running in the running zone, and
in that the threshold is a threshold representative of the length of the running zone.

2. The method for monitoring a cableway installation according to claim 1 comprising determination of receipt of an event indicating exit of the vehicle from the running zone, and transmission of the malfunction signal if the event is not received after the variable has reached the threshold.

3. The method for monitoring a cableway installation according to claim 1 comprising re-initialisation of the variable in response to receipt of an event indicating exit of the vehicle from the running zone, the variable not having reached the threshold.

4. The method according to claim 1, wherein the installation comprises measuring means configured to provide pulses according to the travel of the cable, and calculation of the variable is performed from the pulses provided by the measuring means.

5. The method according to claim 2, wherein the installation comprises detection means designed to transmit a first signal indicating entry of the vehicle in the running zone and designed to transmit a second signal indicating exit of the vehicle from the running zone, and the event corresponds to receipt of the second signal.

6. A monitoring device of a cableway installation, the installation comprising two terminals for passengers to board and alight from at least one vehicle equipped with a clamp and designed to be hauled by the cable between the two terminals, the device comprising:
detection means configured to detect entry of the at least one vehicle in a running zone and exit of the at least one vehicle from the running zone,
calculating means configured to calculate a variable that is representative of a running length of the cable, the calculating means being configured to calculate the variable in response to detection of the at least one vehicle, and
comparison means configured to compare the variable with a threshold, the monitoring device being configured to transmit a malfunction signal (Sd) when the variable reaches the threshold,
wherein in that the detection means are arranged to define a running zone where the at least one vehicle is hauled by the cable, and in that the threshold is a threshold representative of the length of the running zone.

7. The device according to claim 6, comprising measuring means configured to provide pulses according to the travel of the cable, and wherein the calculating means calculate the variable from the pulses provided by the measuring means.

8. The device according to claim 6, wherein the detection means are designed to transmit a first signal indicating entry of the vehicle in the running zone and designed to transmit a second signal indicating exit of the vehicle from the running zone, the determining means comprise a receiver of the first and second signals, and the event corresponds to receipt of the second signal.

9. The device according to claim 6, wherein the installation comprises at least one tower configured to keep the cable above the ground, the at least one tower comprising at least one girder assembly, the length of the running zone being equal to the length of the at least one girder assembly.

10. The device according to claim 5, wherein a single sensor is used per running zone and the sensor has a detection area demarcating the running zone, and wherein the sensor is configured so that when the vehicle enters the detection area, the sensor transmits the first signal indicating entry of the vehicle in the running zone, and when the vehicle exits the detection area, the sensor transmits the second signal indicating exit of the vehicle from the running zone.

11. A cableway installation comprising a cable and a vehicle designed to be hauled by the cable, wherein, it comprises a monitoring device according to claim 5.

12. A method for monitoring a cableway installation, the cableway installation comprising at least one vehicle provided with at least one clamp attaching the at least one vehicle to the cable, the method comprising:
detecting entry of the at least one vehicle in a running zone to trigger calculation of a variable that is representative of a running length of the cable starting from the detection, wherein the at least one clamp is fixed to the cable so that the cable hauls the at least one vehicle when the at least one vehicle is running in the running zone;
comparing the variable with a threshold representative of a length of the running zone;
transmitting a malfunction signal when the variable has reached the threshold.

13. The method for monitoring a cableway installation according to claim 12, comprising determining receipt of an event indicating exit of the at least one vehicle from the running zone, and transmitting the malfunction signal if the event is not received after the variable has reached the threshold.

14. The method for monitoring a cableway installation according to claim 12, comprising re-initialising the variable in response to receipt of an event indicating exit of the at least one vehicle from the running zone, the variable not having reached the threshold.

15. The method according to claim 12, wherein the cableway installation comprising providing pulses according to a travel of the cable for moving the at least one vehicle, and calculating the variable from the pulses.

16. The method according to claim 13, wherein the cableway installation comprises transmitting a first signal indicating entry of the vehicle in the running zone and transmitting a second signal indicating exit of the at least one vehicle from the running zone, and the event corresponds to receipt of the second signal.

17. A monitoring device of a cableway installation, the cableway installation comprising two terminals for passengers to board and alight from at least one vehicle equipped with a clamp and designed to be hauled by the cable between the two terminals, the monitoring device comprising:
a detector configured to detect entry of the at least one vehicle in a running zone and exit of the at least one vehicle from the running zone, the detector defining a running zone where the at least one vehicle is hauled by the cable;
a calculator configured to calculate a variable that is representative of a running length of the cable, the calculator being configured to calculate the variable in response to detection of the at least one vehicle in the running zone, and
a comparator configured to compare the variable with a threshold representative of a length of the running zone,
wherein the monitoring device is configured to transmit a malfunction signal when the variable reaches the threshold.

18. The monitoring device of a cableway installation according to claim 17, comprising a measuring device configured to provide pulses according to the travel of the cable, and wherein the calculator calculates the variable from the pulses.

19. The monitoring device of a cableway installation according to claim 17, comprising a receiver configured to determine receipt of an event indicating exit of the at least one vehicle from the running zone, and configured to transmit the malfunction signal if an event is not received after the variable has reached the threshold,
wherein the detector is designed to transmit a first signal indicating entry of the at least one vehicle in the running zone and designed to transmit a second signal indicating exit of the at least one vehicle from the running zone, the receiver receiving the first and second signals, and the event corresponds to receipt of the second signal.

20. The monitoring device of a cableway installation according to claim 17, wherein the cableway installation comprises at least one tower configured to keep the cable above the ground, the at least one tower comprising at least one girder assembly, the length of the running zone being equal to the length of the at least one girder assembly.

21. The monitoring device of a cableway installation according to claim 19, wherein a single sensor is used per running zone and the sensor has a detection area delimiting the running zone, and wherein the sensor is configured so that when the at least one vehicle enters the detection area, the sensor transmits the first signal indicating entry of the vehicle in the running zone, and when the vehicle exits the detection area, the sensor transmits the second signal indicating exit of the at least one vehicle from the running zone.

22. The cableway installation comprising a cable, at least one vehicle designed to be hauled by the cable, and a monitoring device according to claim 17.
